(19) United States
(12) Patent Application Publication
(10) Pub. No.: US 2021/0245850 A1
(43) Pub. Date: Aug. 12, 2021

(54) Stand for Supporting a Boat

(71) Applicants: Grady F. Smith, Greenville, NC (US); Lennart Hans Carlsson, Tyreso (SE)

(72) Inventors: Grady F. Smith, Greenville, NC (US); Lennart Hans Carlsson, Tyreso (SE)

(21) Appl. No.: 17/174,721

(22) Filed: Feb. 12, 2021

Related U.S. Application Data
(60) Provisional application No. 62/975,702, filed on Feb. 12, 2020.

(51) Int. Cl. B63C 5/02; F16M 11/10; F16M 11/24

(52) U.S. Cl. CPC B63C 5/02; B63C 2005/022; F16M 11/24; F16M 11/10

(57) ABSTRACT

A boat stand to support a boat above a support surface. The boat stand includes a support column and a top pad pivotally mounted to the support column. The top pad includes a plate, a mount with a receptacle that receives a head of the support column, and at least one wing with an opening to connect a chain.

### RELATED APPLICATIONS

This application claims the benefit of U.S. Provisional Application No. 62/975,702, filed Feb. 12, 2020, the disclosure of which is incorporated herein by reference in its entirety.

### TECHNICAL FIELD

The present disclosure relates generally boat stands and, more specifically, to boat stands that are adjustable and securely support a boat.

### BACKGROUND

Boat stands are used to support boats during dry storage or repair. A typical boat stand generally comprises a vertical support with a height adjustment mechanism and a top pad that contacts the hull of the boat. A boat is typically supported by a plurality of boats stands. Boat stands on opposing sides of the boat are connected by a chain to prevent the lateral thrust caused by the weight of the boat from pushing the stands apart.

The top pad is typically made of wood and is fastened to a backing plate that pivotally connects the top pad to the vertical support. The backing plate comprises a short length of angle iron that extends across the underside of the top plate and a cylindrical receptacle to receive the upper end of a support column. The top pad is secured to the backing plate by countersunk screws that thread into machined screw holes in the backing plates. The screws securing the top plate are often coated with paint or other protective coating to prevent rusting of the screws. The backing plate extends generally parallel to the axis of rotation and includes holes or slots at the outer ends thereof for attaching a chain that connects the boat stands.

One problem with the conventional design is that the chain connecting the boat stands tends to pull and twist the top pad causing movement of the screws fastening the top pad to the backing plate. The movement of the screws wears away the paint or protective coating on the screws and create gaps that allow water intrusion into the screw holes. The intrusion of water with high salt content causes corrosion of the screws fastening the top plate to the backing plate as well as to the internal threads in the backing plate. Due to the corrosion, the connection between the top pad and the backing plate often fails, requiring frequent replacement and/or repair of the top plate.

Another problem is created by the geometry of the backing plate. The backing plate in conventional prior art boat stands extends generally parallel to the pivot axis of the top pad. As noted above, openings are formed in the outer ends of the backing plate for connecting a chain. The location of the openings for connecting the chains provides a large moment arm that amplifies the twisting forces on the top pad when the chain is tightened exacerbating the connection failure problem discussed above. The frictional forces generated due to the twisting of the top plate can cause the pivot mechanism to bind and prevent rotation of the top plate on the pivot axis. Further, the geometry in the conventional design allows for rotation of the top plate over time, which can create slack in the chain. If too much slack is created, the lateral thrust of the hull against the boat stand can push the boat stands apart and cause the boat to fall.

The geometry and materials used for the top pad in the conventional boat stand design also create some problems. The conventional boat stands on the market have a one-size-fits-all top pad approximately 12 inches square and made of wood. This one-size-fits-all top pad may come into contact with strakes, chines or spray rails on the hull of the boat creating a gap between the center of the top pad and the hull. When the top pad is lifting from the hull by contact with a strake, chine or spray rail, the weight of the boat can crack the top plate. The wood material used for the top pad can also mar or blemish the gel coat or coating applied to the hull of the boat.

### SUMMARY

One aspect is directed to a boat stand to support a boat above an underlying surface. The boat stand comprises a support column, a top pad pivotally mounted to an upper end of the support column to rotate about a pivot axis. The top pad comprises a plate configured to contact the hull of the boat, a mount disposed on a bottom side of the plate and having a receptacle that receives a head of the support column, and at least one wing extending outwardly from the receptacle generally perpendicular to the pivot axis with the wing having an opening formed therein to connect a chain to the top pad.

In another aspect, the receptacle comprises a generally cylindrical sleeve, and the top pad comprises two wings extending in opposing directions from diametrically opposing sides of the receptacle with each wing including an opening for connecting a chain to the top pad.

In another aspect, the wings connect to the receptacle on a tangent.

In another aspect, the receptacle comprises a generally cylindrical sleeve, and the top pad comprises a plurality of wings that extend radially outward from the receptacle.

In another aspect, a fastener extends through the head of the support column and the mount to attach the top plate to the support column.

In another aspect, the head of the support column comprises an elongated opening that receives the fastener with the elongated opening comprising a length measured along the centerline of the support column that is greater than a width of the fastener.

In another aspect, the plate, the mount, and the at least one wing are made of metal and have a unitary construction.

In another aspect, a cover made of a resilient material extends across a top surface of the plate with the cover being constructed from a different material than the plate.

In another aspect, the plate is pivotal connected to the support column and configured to rotate up to 20° on each side of a perpendicular home position.

In another aspect, the receptacle is centered on the bottom side of the plate.

In another aspect, the mount and the two wings are constructed from a pair of sections that include the same shape and size.

One aspect is directed to a boat stand to support a boat above an underlying surface. The boat stand comprises a support column and a top pad mounted to an upper end of the support column. The top pad comprises: a plate configured to contact the hull of the boat; a mount disposed on a bottom side of the plate and having a receptacle that receives a head of the support column; and at least one wing extending outwardly from the receptacle and having an opening formed therein to connect a chain to the top pad. The plate, the mount, and the at least one wing comprise a unitary construction.

In another aspect, the receptacle comprises a generally cylindrical sleeve, and the top pad comprises two wings extending in opposing directions from diametrically opposing sides of the receptacle with each wing including an opening for connecting a chain to the top pad.

In another aspect, the wings connect to the receptacle on a tangent.

In another aspect, a cover made of a resilient material extends across a top surface of the plate with the cover being constructed from a different material than the plate.

In another aspect, a width of the plate is one-half or less a length of the plate.

In another aspect, the mount and the at least one wing are constructed from a pair of sections that include the same shape and size.

One aspect is directed to a boat stand to support a boat above an underlying surface. The boat stand comprises a support column, and a top pad pivotally mounted to an upper end of the support column to rotate about a pivot axis. The top pad comprises: a plate configured to contact the hull of the boat with the plate comprising a width and a length with the width one-half or less of the length; a mount disposed on a bottom side of the plate to receive an end of the support column; and at least one wing extending outwardly from the mount and comprising an opening formed therein to connect a chain to the top pad.

In another aspect, a cover is removably attached to the plate with the cover having a different construction than the plate.

In another aspect, the plate comprises a top surface that is flat.

### BRIEF DESCRIPTION OF THE DRAWINGS

FIG. 1 is a side view of a boat stand.

FIG. 2 is a schematic side view of a plate attached to and positioned at various angular positions relative to a support column.

FIG. 3 is a perspective view of an upper section of a boat stand that includes a top pad mounted to a support column.

FIG. 4 is a top perspective view of a cover extending over a plate.

FIG. 5 is a top plan view of a cover.

FIG. 6 is a bottom perspective view of mount positioned on a bottom of a plate.

FIG. 7 is a bottom perspective view of mount positioned on a bottom of a plate.

FIG. 8 is a perspective view of a screw and a fastener.

FIG. 9A is a schematic side view of a plate at a first pivotal position relative to a screw.

FIG. 9B is a schematic side view of the plate of FIG. 9B at a second pivotal position relative to the screw.

FIG. 10 is a schematic section view of the boat stand of FIG. 1.

FIG. 11 is a side view of a pair of boat stands contacting against and supporting a boat.

FIG. 12 is a schematic view of a fastener securing a support column head in a receptacle of a plate.

FIG. 13 is a flowchart diagram of a method of using a boat stand and supporting a boat.

FIG. 14 is a perspective view of a plate with a bowed shape.

### DETAILED DESCRIPTION

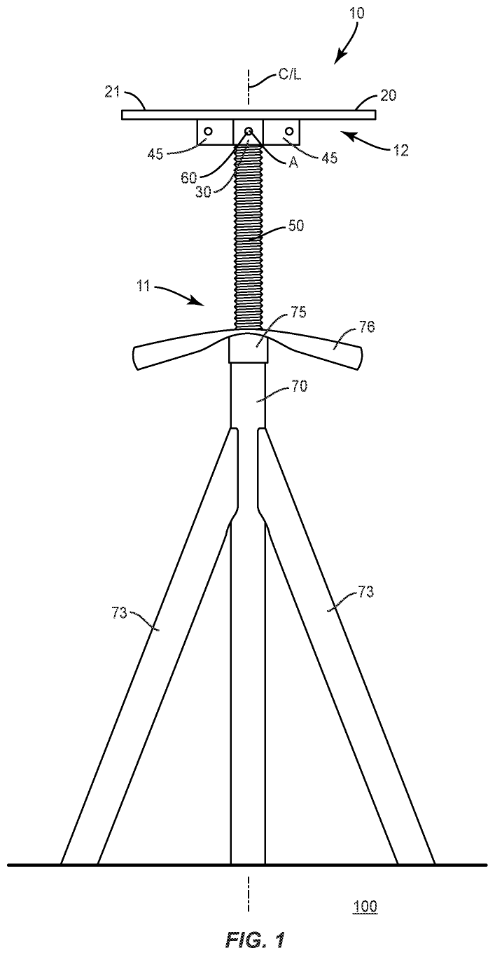

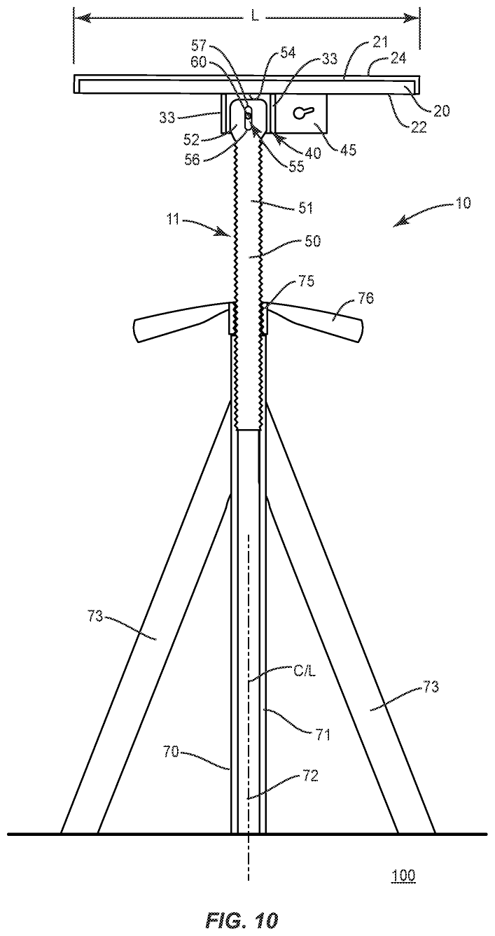

FIGS. 1 and 10 illustrate a boat stand 10 to stabilize and support a boat, such as a boat that is out of the water. A boat stand 10 includes a support column 11 configured to engage an underlying support surface 100 (e.g., ground). A top pad 12 is mounted to the support column 11 and can pivot to rotate about a pivot axis A. The top pad 12 is configured to contact a hull of the boat.

The support column 11 comprises a tube 70 and a screw 50. The tube 70 includes an elongated shape with a hollow interior 72. The tube 70 includes an inner width sized to receive the screw 50. One or more legs 73 extend outward from and support the tube 70. The legs 73 can support the tube 70 at various angular positions relative to the support surface 100. FIGS. 1 and 10 illustrate the tube 70 substantially perpendicular to the support surface 100. Other orientations can locate the tube 70 at various non-perpendicular positions.

A crank 75 is threaded onto the screw 50 and is positioned vertically above the tube 70. One or more handles 76 extend radially outward from a threaded body of the crank 75 for the user to apply a rotational force. The crank 75 is rotatable relative to the screw 50 in first and second directions to adjust the vertical position of the screw 50 and attached top pad 12.

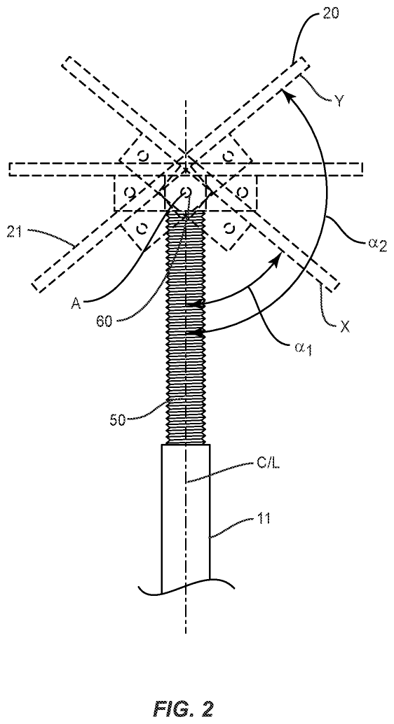

The top pad 12 includes a plate 20, a mount 30, and at least one wing 45. The plate 20 is configured to contact against the boat. The plate 20 is pivotable about axis A to adjust to the shape of the boat. The plate 20 further includes an enlarged face 21 to contact the boat across a relative wide area. FIG. 2 schematically illustrates the plate 20 pivotally attached by a fastener 60 to the screw 50 at point A. The face 21 of the plate 20 is positioned at an angle relative to a centerline C/L of the screw 50. The plate 20 is adjustable between a first position X that is at an angle α1, and a second position Y that is at an angle α2. The extent of movement relative to the screw 50 can vary between angles α1 and α2. In one example, the range between angle α1 and angle α2 is about 40°. In one example, the plate 20 can pivot 20° to each side of the centerline C/L. This extent of pivoting movement about point A provides for the plate 20 to face in different lateral directions and to support a boat at various positions relative to the screw 50.

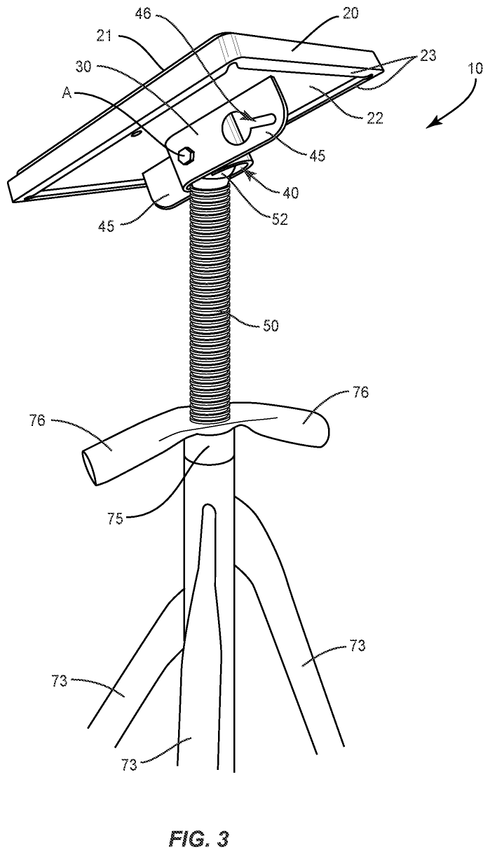

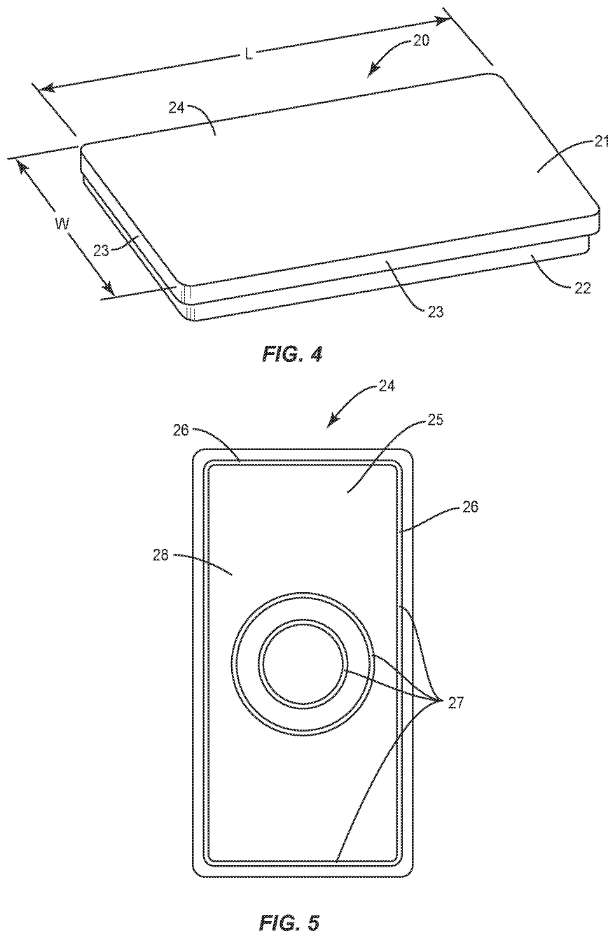

As illustrated in FIGS. 3 and 4, the plate 20 includes the face 21, an opposing bottom 22, and sidewalls 23. The plate 20 can include a variety of other shapes, including but not limited to circular, oval, trapezoidal, square and rectangular. The plate 20 includes a length L and a width W. In one example, the width W is ½ or less of the length L.

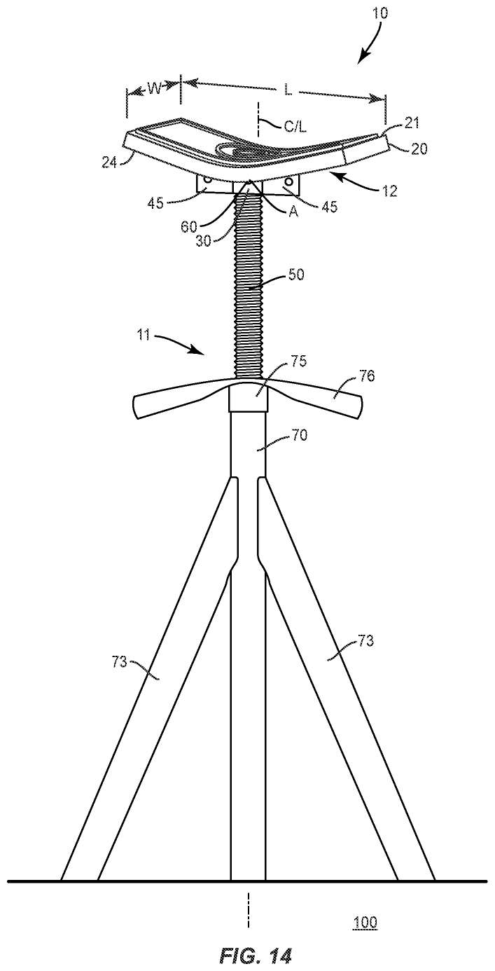

In one example as illustrated in FIG. 4, the face 21 is flat. In another example as illustrated in FIG. 14, the face 21 is bowed with the outer ends along the length L being vertically above a lowered central section. In another example, face 21 includes an irregular shape to conform to a specific shape of the boat. The face 21 can include knurling or other surface configurations that improve the contact with the boat.

A cover 24 is mounted to the plate 20. The cover 20 is constructed from a different material than the plate 20 and can be fixedly mounted to the plate 20 or removably mounted to the plate 20. The cover 24 extends across the face 21 and is constructed from an elastomeric material, such as rubber to improve the contact with the boat. The cover 24 can also prevent or reduce the plate 20 from scratching the boat. As illustrated in FIG. 5, one or more extensions 27 extend outward from the face 28 to enhance contact with the boat hull. In one example as illustrated in FIG. 5, the extensions 27 can be positioned centrally on a first section 25 that extends over the face 21 of the cover. Extensions 27 can also be positioned along the edges of the first section 25. The different extensions 27 can extend outward the same or different distances from the face 28. In one example as illustrated in FIG. 5, each of the extensions 27 extends outward from the face 28 an equal amount.

As illustrated in FIG. 4, the cover 24 includes a first section 25 that extends across the face 21 of the plate 20. The cover 24 can also include one or more walls 26 that extend along a portion or entirety of the sidewalls 23 of the plate 20. As illustrated in FIG. 3, the cover 24 can wrap around the sidewalls 23 of the plate 20 and extend along a limited section of the bottom 22 of the plate 20.

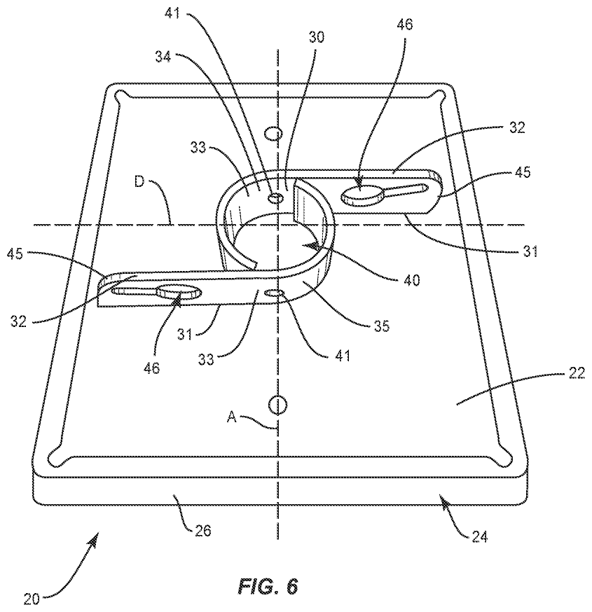

The top pad 12 also includes a mount 30 that extends from the bottom 22 of the plate 20. The mount 30 forms a receptacle 40 that receives the head 52 of the screw 50. FIG. 6 illustrates the underside of the plate 20 that includes the mount 30. The mount 30 is formed by one or more walls 33 that extend outward away from the bottom 22 of the plate 20. The one or more walls 33 can extend completely around the entirety of the receptacle 40 as illustrated in FIG. 6 or around one or more limited sections of the receptacle 40.

The one or more walls 33 include a first edge 31 that faces towards and is secured to the bottom 22 of the plate 20 and an exposed second edge 32. The mount 30 is secured to the bottom 22 of the plate 20 in various manners such as but not limited to one or more of welding, soldering, brazing, adhesives, and mechanical fasteners. The bottom 22 of the plate 20 forms the back of the receptacle 40 and contacts against the first end of the screw 50.

Openings 41 extend through opposing sections of the one or more walls 33. The openings 41 are aligned along the pivot axis A about which the plate 20 pivots. The openings 41 are sized to receive the fastener 60 to attach the plate 20 to the screw 50.

The top pad 12 also includes one or more wings 45. The wings 45 extend outward from opposing lateral and axial sides of the receptacle 40. The wings 45 are tangent to the receptacle 40 and extend outward on diametrically opposing sides of the receptacle 40. As illustrated in FIG. 6, the wings 45 are positioned on opposing sides of the axis A. In one example, the wings 45 are perpendicular to the axis A. The wings 45 are also positioned on opposing sides of a second axis D that is perpendicular to axis A. In one example, each of the wings 45 extends outward from the receptacle 40 and is parallel to the axis D and parallel to each other. The axes A and D intersect at a center of the receptacle 40. In one example, the intersection is at the center of the plate 20. In another example, the intersection is offset from the center of the plate 20.

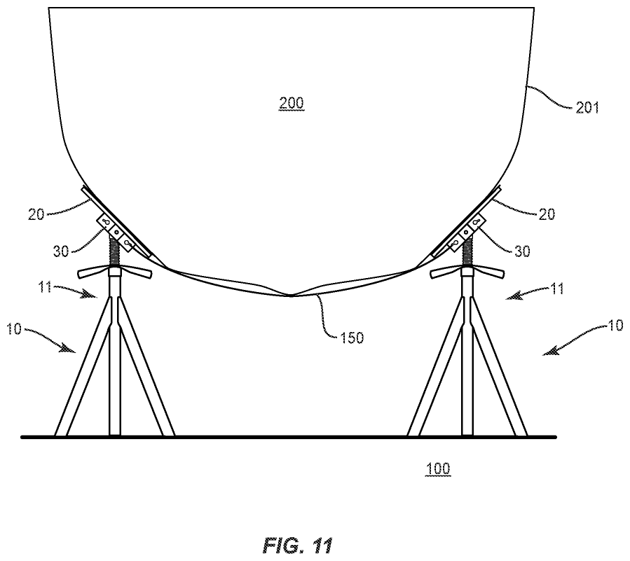

The wings 45 form connection points for securing a chain. Openings 46 are positioned in each wing 45 and are spaced away from the receptacle 40. The openings 46 provide for securing the chain to the boat stand 10 (as illustrated in FIG. 11 and described below).

In one example, the mount 30 and wings 45 are constructed from two wall members 34, 35. The wall members 34, 35 each have the same shape and size and are interchangeable with a curved section at one end and a straight section at an opposing end. The wall members 34, 35 are secured together to form a single unitary mount 30.

In one example, the top pad 12 includes a pair of wings 45 as illustrated in FIG. 6. In another example, the top pad 12 includes a single wing 45 that extends outward from the mount 30. In one example, the single wing 45 is tangent to the receptacle 40.

The top pad 12 includes the plate 20, mount 30, and at least one wing 45. The top pad 12 has a unitary construction. In one example, the top pad 12 is formed as a single piece. In another example, the different components can be connected together to form the unitary construction. The connection can be accomplished by one or more of welding, soldering, brazing, adhesives, and mechanical fasteners.

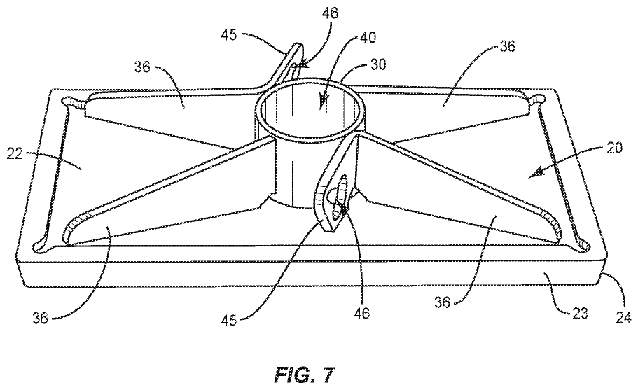

In one example as illustrated in FIG. 7, one or more ribs 36 enforce the mount 30 and/or the wings 45. The ribs 36 are positioned along the bottom 22 of the plate 20 and extend outward towards the sidewalls 23 of the plate 20 and away from the receptacle 40. The ribs 36 can include various shapes, sizes, and configurations. In one example, a single elongated member is bent with a first end forming a rib 36 and the second end forming a wing 45. The ribs 46 are permanently connected to the top pad 12 in a unitary construction. In the example of FIG. 7, the cover 24 extends onto a section of the bottom side 22 of the plate 20. The cover 24 is spaced away from the ribs 46, wings 45, and mount 30.

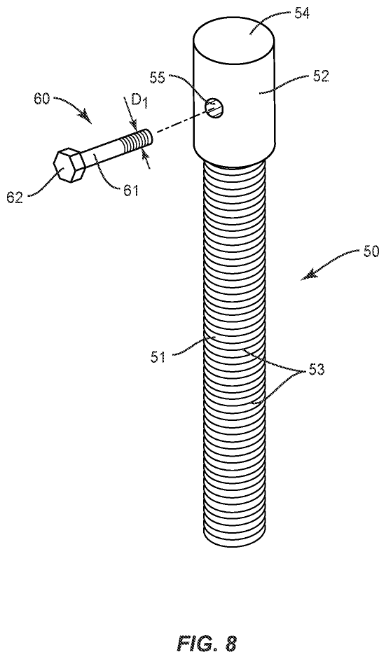

The support column 11 includes the screw 50 that contacts the plate 20. As illustrated in FIG. 8, the screw 50 includes a threaded elongated shaft 51 and a head 52 at the first end. Threads 53 extend along a section or entirety of the shaft 51. The head 52 is sized to fit within the receptacle 40. In one example, the head 52 includes a circular sectional shape that matches and fits within the circular receptacle 40. In other examples, the head 52 and receptacle 40 each include non-circular sectional shapes. In another example, the head 52 includes a first sectional shape and the receptacle 40 includes a different second sectional shape. In each of the various examples, the head 52 is sized to seat within the receptacle 40.

The head 52 includes an end 54 that contacts against the bottom 22 of the plate 20. In one example as illustrated in FIG. 8, the end 54 is flat. The end 54 can include other shapes, including but not limited to hemi-spherical and domed. An opening 55 extends through the head 52 and is positioned axially inward from the end 54. The opening 55 is sized to receive the fastener 60 to attach the plate 20 to the support column 50.

The fastener 60 extends through the opening 55 of the screw 50 and openings 41 in the receptacle 40 to attach the plate 20 to the screw 50. The fastener 60 includes a shaft 61 sized to fit into the openings 41, 55. An enlarged head 62 is positioned at one end of the shaft 61 and is larger than the shaft 61 and the openings 41, 55. An opposing end of the shaft 61 can be threaded to receive a nut to secure the fastener 60.

In one example, the opening 55 is larger than the width W of the shaft 61 to provide for the plate 20 to move axially relative to the screw 50. In another example, the openings 41 in the mount 30 are larger than the shaft 61 to provide for the axial movement. In another example, each of the openings 41, 55 are larger than the shaft 61.

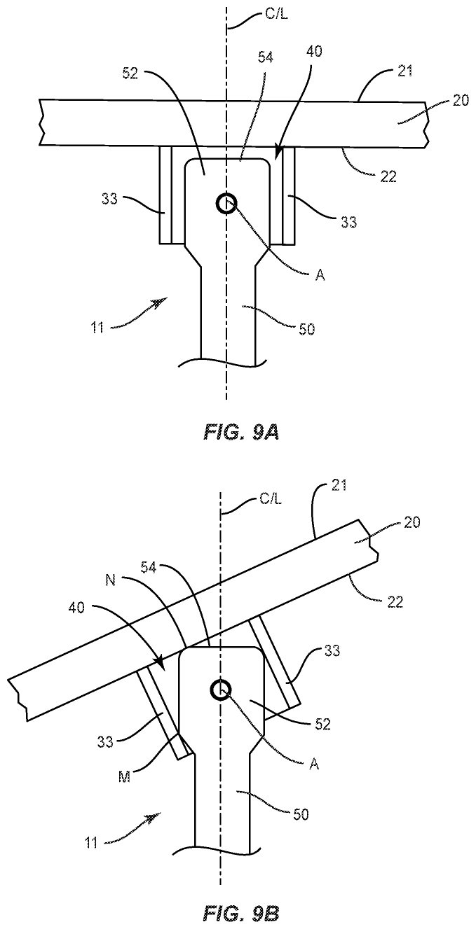

FIGS. 9A and 9B illustrates the movement of the plate 20 relative to the screw 50. As illustrated in FIG. 9A, the plate 20 is pivotable about the pivot axis A and axial movable along the centerline C/L. This occurs prior to engage with the boat. This provides for adjusting the position of the plate 20 and moving the plate 20 into contact with the boat. As illustrated in FIG. 9B, the plate 20 pivots to accommodate the shape of the boat. During contact, the bottom side 22 of the plate 20 contacts against the top edge 54 of the screw 50 at a first point N. Further, the wall 33 of the receptacle 40 contacts against the head 52 of the screw 50 at a second point M. This contact provides for the support column 11 to support the boat.

FIG. 10 illustrates a section view of the boat stand 10. The plate 20 is secured to the screw 50 of the support column 11 with the fastener 60 that extends through the opening 55 in the screw 50 and openings 41 in walls 33 of the receptacle 40. FIG. 10 illustrates the plate 20 perpendicular to the centerline C/L of the support column 11. The plate 20 can pivot about the fastener 60 to position the plate 20 at non-perpendicular angles relative to the support column 11. This angular adjustability provides for the plate 20 to contact against boats of various shapes and sizes. As illustrated in FIG. 10, the outer edges of the head 54 can include chamfers to accommodate the angular positions of the plate 20. As illustrated in FIG. 10, the opening 55 is centered along the centerline C/L of the support column 11. In other examples, the opening 55 is offset from or extends across the centerline C/L.

FIG. 11 schematically illustrates a pair of boat stands 10 supporting a boat 200. The boat stands 10 are on opposing sides of the boat 200 with the plates 20 contacting against opposing sides of the hull 201. The plates 20 are angled relative to their respective vertical supports 11 to contact against hull 201. A chain 150 extends under the hull 150 and is secured to a wing 45 each of the boat stands 10. The chain 150 can be tightened to maintain the boat stands 10 in contact with the boat 200. Various numbers of boat stands 10 can be used to support the boat 200 such that the hull 201 is positioned above the floor 100. In one example, multiple pairs of boat stands 10 are positioned along the length of the boat with each pair being connected together by a chain 150.

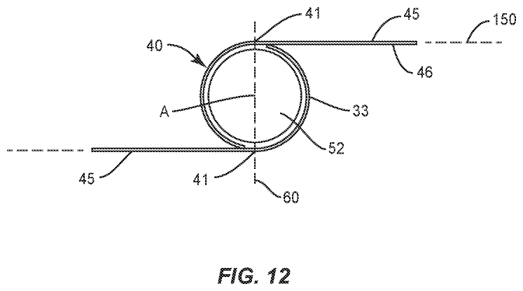

FIG. 12 illustrates a schematic diagram of the head 52 of screw 50 positioned in the receptacle 40. A fastener 60 extends through the head 52 and openings 41 in the walls 33 of the receptacle 40. The fastener 60 secures the plate 20 to the screw 50. The plate 20 (not illustrated in FIG. 12) is pivotal about a pivot axis A that is formed by the fastener 60. The fastener 60 is aligned transverse to the wings 45. In one example, the fastener 60 is perpendicular to the wings 45. In one example, the wings 45 are diametrically opposed, tangent to the receptacle 40, and perpendicular to the pivot axis A.

As further illustrated in FIG. 12, the chain 150 is attached to and extends outward from one of the wings 45. The chain 150 extends along the boat and attaches to a corresponding boat stand 10 (see FIG. 11). A force applied to the boat stand 10 through the chain 150 is transverse to the fastener 60. In one example, the force is perpendicular to the fastener 60.

Further, the attachment of the chain 150 to the wings 45 that are tangent to the receptacle 40 reduces the twisting force applied to the boat stand 10. The backing plate in conventional prior art boat stands extends generally parallel to the pivot axis of the top pad 12 and the openings for connecting the chain are formed in the outer ends of the backing plate. This location of the openings provides a large moment arm that amplifies the twisting forces on the top pad when the chain is tightened exacerbating the connection failure problem discussed above. The frictional forces generated due to the twisting of the top plate can cause the pivot mechanism to bind and prevent rotation of the top plate on the pivot axis. Further, the geometry in the conventional design allows for rotation of the top plate over time, which can create slack in the chain. If too much slack is created, the lateral thrust of the hull against the boat stand can push the boat stands apart and cause the boat to fall. The positioning of the openings 46 of the present application reduces these forces that act on the boat stand 10.

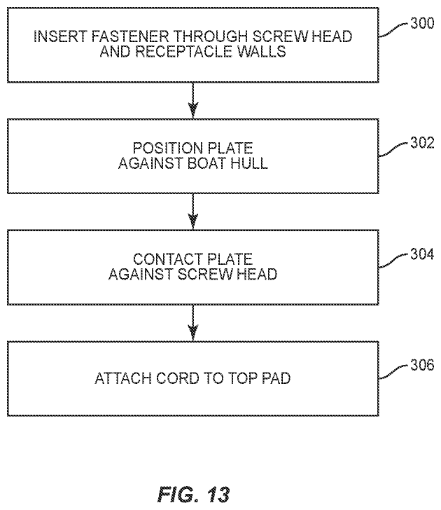

FIG. 13 illustrates a method of using the boat stand 10 to support a boat 200. The top pad 12 is attached to the support column 11 by attaching the plate 20 to the screw 50 by inserting the fastener 60 through the openings 41 in the receptacle walls 33 and the opening 55 in the support column head 52 (block 300).

The boat stand 10 is then moved into position relative to the boat 200 with the plate 20 contacting against the boat hull 201 (block 302). The top pad 12 can be pivoted relative to the support column 11 to correspond to the angular shape of the boat hull 201. The positioning can also include rotating the crank 75 to adjust the vertical position of the support column 11 and thus contact the plate 20 against the boat hull 201.

As the plate 20 is moved into contact with the boat hull 201, the bottom 22 of the plate 20 contacts against and is support by the end 54 of the screw head 52 (block 304). This provides for the weight of the boat 200 to be transferred from the plate 20 and through the support column 11.

A chain 150 is attached to one of the wings 45 of the top pad 12 (block 306). The chain 150 is positioned under the boat hull 201 and attached to a boat stand 10 on the opposing side. The chain 150 can be tensioned to secure the boat 200 onto the boat stands 10.

In another method, the boat stand 10 supports the boat 200 without use of the chain 150.

The plate 20 and support column 50 can be constructed from various materials, such as but not limited to metals such as steel and aluminum. The different components can be constructed from the same or different materials.

By the term “substantially” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

What is claimed is:

1. A boat stand to support a boat above an underlying surface, the boat stand comprising:
a support column;
a top pad pivotally mounted to an upper end of the support column to rotate about a pivot axis, the top pad comprising:
a plate configured to contact the hull of the boat;
a mount disposed on a bottom side of the plate and having a receptacle that receives a head of the support column, and
at least one wing extending outwardly from the receptacle generally perpendicular to the pivot axis, the wing having an opening formed therein to connect a chain to the top pad.

2. The boat stand of claim 1 wherein:
the receptacle comprises a generally cylindrical sleeve; and
the top pad comprising two wings extending in opposing directions from diametrically opposing sides of the receptacle, each wing including an opening for connecting a chain to the top pad.

3. The boat stand of claim 2 wherein the wings connect to the receptacle on a tangent.

4. The boat stand of claim 1 wherein:
the receptacle comprises a generally cylindrical sleeve; and
the top pad comprises a plurality of wings that extend radially outward from the receptacle.

5. The boat stand of claim 1 further comprising a fastener that extends through the head of the support column and the mount to attach the top plate to the support column.

6. The boat stand of claim 5 wherein the head of the support column comprises an elongated opening that receives the fastener, the elongated opening comprising a length measured along the centerline of the support column that is greater than a width of the fastener.

7. The boat stand of claim 1 wherein the plate, the mount, and the at least one wing are made of metal and have a unitary construction.

8. The boat stand of claim 1 further comprising a cover made of a resilient material that extends across a top surface of the plate, the cover being constructed from a different material than the plate.

9. The boat stand of claim 1 wherein the plate is pivotal connected to the support column and configured to rotate up to 20° on each side of a perpendicular home position.

10. The boat stand of claim 1 wherein the receptacle is centered on the bottom side of the plate.

11. The boat stand of claim 2 wherein the mount and the two wings are constructed from a pair of sections that include the same shape and size.

12. A boat stand to support a boat above an underlying surface, the boat stand comprising:
a support column;
a top pad mounted to an upper end of the support column, the top pad comprising:
a plate configured to contact the hull of the boat;
a mount disposed on a bottom side of the plate and having a receptacle that receives a head of the support column, and
at least one wing extending outwardly from the receptacle and having an opening formed therein to connect a chain to the top pad;
wherein the plate, the mount, and the at least one wing comprise a unitary construction.

13. The boat stand of claim 12 wherein:
the receptacle comprises a generally cylindrical sleeve; and
the top pad comprising two wings extending in opposing directions from diametrically opposing sides of the receptacle, each wing including an opening for connecting a chain to the top pad.

14. The boat stand of claim 13 wherein the wings connect to the receptacle on a tangent.

15. The boat stand of claim 12 further comprising a cover made of a resilient material that extends across a top surface of the plate, the cover being constructed from a different material than the plate.

16. The boat stand of claim 12 wherein a width of the plate is one-half or less a length of the plate.

17. The boat stand of claim 12 wherein the mount and the at least one wing are constructed from a pair of sections that include the same shape and size.

18. A boat stand to support a boat above an underlying surface, the boat stand comprising:
a support column;
a top pad pivotally mounted to an upper end of the support column to rotate about a pivot axis, the top pad comprising:
a plate configured to contact the hull of the boat, the plate comprising a width and a length with the width one-half or less of the length;
a mount disposed on a bottom side of the plate to receive an end of the support column, and
at least one wing extending outwardly from the mount and comprising an opening formed therein to connect a chain to the top pad.

19. The boat stand of claim 18 further comprising a cover that is removably attached to the plate, the cover having a different construction than the plate.

20. The boat stand of claim 18 wherein the plate comprises a top surface that is flat.
